(19) United States
(12) Patent Application Publication
(10) Pub. No.: US 2026/0369441 A1
(43) Pub. Date: Nov. 19, 2026

(54) DEVICE FOR PRODUCING ELECTRIC POWER FROM THERMALIZED NEUTRONS AND GAMMA RAYS

(71) Applicant: Philip Brien Ugorowski, National City, MI (US)

(72) Inventor: Philip Brien Ugorowski, National City, MI (US)

(21) Appl. No.: 19/345,856

(22) Filed: Sep. 30, 2025

Related U.S. Application Data
(60) Provisional application No. 63/804,863, filed on May 13, 2025.

(51) Int. Cl. G21H 1/10; G21H 1/04

(52) U.S. Cl. CPC G21H 1/10; G21H 1/04

(57) ABSTRACT

A multilayered energy conversion device is provided for use in applications such as active shielding and nuclear batteries. The device includes a neutron/gamma absorber layer. The neutron/gamma absorber layer is in electrical communication with an electrical lead attachable to an external circuit. An insulating layer is disposed on one face of the neutron/gamma absorber layer, and a conductive absorber layer is disposed on the opposing face of the insulating layer. The conductive absorber layer is in electrical communication with an electrical lead attachable to the external circuit.

### I. CROSS REFERENCE TO RELATED APPLICATIONS

This application claims the benefit of U.S. Provisional Patent Application No. 63/804,863 filed May 13, 2025 and now pending, which is incorporated herein by reference in its entirety.

### II. BACKGROUND OF THE INVENTION

### A. Field of Invention

The invention generally relates to materials, devices, and methods for converting neutron radiation to electrical energy.

### B. Description of the Related Art

Generating electric power from nuclear processes is well-known. For instance, nuclear batteries are known. One type is known as Radioisotope Thermoelectric Generators (RTGs). RTGs use thermocouples to produce electricity from the heat generated through radioactive decay. Energy conversion in RTGs is inefficient and are relatively heavy and costly on a per watt basis as compared to other energy sources. Nuclear batteries in general are inherently very low power because they rely on natural radioactive decay.

Radiovoltaic Devices (RVs). are also known. A radiovoltaic device converts the energy of ionizing radiation directly into electricity using a semiconductor junction, similar to the conversion of photons into electricity in a photovoltaic cell. Their useful life tends to be limited because semiconductor materials are prone to damage from radiation-induced defects.

Higher-power Radioisotope Power Systems (RPSs) are also known. These devices use alpha emitters like Pu-238, to harvest the kinetic energy of the ejected alpha particle. The alpha particle collides with the device, converting the energy into heat, which is then transformed into electrical energy by thermocouples, Sterling engines or Brayton engines. Thermocouples have no moving parts, but they have an efficiency of less than 8%. Sterling engines have minimal moving parts, with efficiencies of about 30%. Brayton engines are the most complex, with an electrical energy conversion around 40%. As the efficiency of these methods increases, so does weight and complexity.

Passive nuclear shielding is also known. Nuclear reactors are usually passively shielded with large masses of materials like concrete, lead, or tungsten, to keep neutrons and gamma rays from escaping into the surrounding area and presenting a health hazard. The small reactors planned for habitats on the Moon, Mars, or elsewhere require lighter shielding materials. Transporting heavy passive shielding from Earth comes at a high cost of propellant, and making shielding materials from local materials requires an existing construction infrastructure.

What is needed is a light, reliable, active shielding device for converting neutron and/or gamma radiation to electrical energy. Some embodiments of the present invention may provide one or more benefits or advantages over the prior art.

### III. SUMMARY OF THE INVENTION

The present disclosure describes an active shield for a nuclear radiation, which has applications in generating electrical energy from radiation emitted by nuclear reactors, nuclear waste, or any other source of neutron and/or gamma radiation. An active shield would provide protection from radiation, while also generating electrical current and possibly also accumulating useful material for an off-Earth habitat or for trade.

A neutron and gamma energy conversion device is provided. The device comprises a housing having an interior surface enclosing a multilayered energy conversion member. At least a portion of the housing is suitably transparent to neutron radiation to permit an operative amount of neutron radiation to pass through the housing and impinge the multilayered energy conversion member. The device further includes an insulating member disposed on the interior surface of the housing. The multilayered energy conversion member comprises a neutron absorber layer disposed on the insulating member, wherein the neutron absorber layer is in electrical communication with an electrical lead attachable to an external circuit. A first insulating layer is disposed on a face of the neutron absorber layer opposing the insulating member, a conductive absorber layer is disposed on the insulating layer, wherein the conductive absorber layer is in electrical communication with an electrical lead attachable to the external circuit.

Other benefits and advantages will become apparent to those skilled in the art to which it pertains upon reading and understanding of the following detailed specification.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof, wherein like reference numerals indicate like structure, and wherein:

FIG. 1A is a schematic drawing of two nuclear fission reactions of boron-10 with a thermal neutron;

FIG. 1B is a schematic drawing of a nuclear fission reaction of lithium-6 with a thermal neutron;

FIG. 2 is a schematic drawing illustrating the interaction of a neutron with a neutron absorber layer and conductive absorber layer;

FIG. 3 is a schematic drawing of an active shielding device according to one embodiment;

FIG. 4 is a schematic drawing of an active shielding device having an external moderator member;

FIG. 5 is a schematic drawing of an active shielding device having an internal moderator member;

FIG. 6 is a schematic drawing of an active shielding device having a moderator incorporated into the neutron absorber layer.

FIG. 7 is a log-log plot illustrating neutron absorption characteristics of various materials;

FIG. 8 is a linear-linear plot illustrating neutron absorption characteristics of various materials;

FIG. 9 is plot illustrating alpha particle production;

FIG. 10 is a plot illustrating triton particle production; and

FIG. 11 is a plot illustrating total electrons produced.

### V. DETAILED DESCRIPTION OF THE INVENTION

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

Terms of degree, terms of approximation, and/or subjective terms may be used herein to describe certain features or elements of the invention. In each case sufficient disclosure is provided to inform the person having ordinary skill in the art in accordance with the written description requirement and the definiteness requirement of 35 U.S.C. 112.

The person of ordinary skill will recognize certain interchangeable notations indicating isotopes. For example, 6Li, Li-6, and lithium-6 are all equivalent ways of indicating lithium having an atomic mass number of six. Each of these conventions for identifying isotopes are used herein, and the skilled artisan will readily understand their meaning.

A process of energy conversion according to embodiments of the invention includes placing a neutron and/or gamma absorbing component in a radiation field. The radiation may be emitted by a nuclear reactor or nuclear waste in active shielding embodiments, or by a neutron-emitting material, such as californium-252 or americium-beryllium in stand-alone nuclear battery embodiments. Another embodiment involves protecting the interior of spacecraft from cosmic radiation, namely protons impinging the outer skin of the craft, which creates neutrons. Placing the embodiment inward of the outer skin would protect people and electronics inside the spacecraft from the neutron radiation produced in the skin.

Neutron absorbing components may include or may work in conjunction with a means for thermalizing high-speed neutrons. Neutrons emitted by a nuclear reactor are high-speed neutrons, which are not efficiently absorbed by neutron absorbers like ¹⁰B or ⁶Li. Adding a component rich in a moderator such as hydrogen tends to slow, or “thermalize”, high-speed neutrons allowing more efficient absorption and therefore more efficient energy conversion. A means for thermalizing neutrons can comprise a hydrogen-rich layer between the neutron source and the neutron absorber, or by making a single layer incorporating both a moderator and an absorber. For instance, lithium may serve as the neutron absorber in the form of lithium-six-hydride (⁶LiH). The hydrogen of a lithium hydride layer will tend to slow the neutrons to a range where the lithium-6 can more efficiently absorb them. As described in more detail elsewhere herein, moderators of the present invention are not limited to hydrogen. Moreover, the person of ordinary skill will readily understand that every element has neutron moderation properties to some extent. Whether or not they are considered moderators is a matter of degree. Some elements are relatively efficient at both. Such elements, like Li-6, can function as both moderator and absorber.

The person of ordinary skill will readily understand that the invention is not limited to lithium-6-hydride, and that other known neutron absorbers can comprise embodiments of the invention in their elemental form, as a hydride or deuteride, or as a combination of elemental and hydride/deuteride forms. Known neutron absorbers suitable for this purpose include boron, cadmium, gadolinium, hafnium, samarium, dysprosium, erbium, and europium. Embodiments can comprise any of these alone or in combination with each other, or in combination with other metals, in their elemental and/or hydride/deuteride form. Additionally, the person of ordinary skill will readily understand that the invention is not limited to hydrogen and deuterium moderators for thermalizing neutrons. Other known neutron moderators can be substituted or used in combination with hydrogen. Such moderators include carbon-12 (graphite), beryllium-9, and Li-7; and various hydrides, or their corresponding deuterides, such as, without limitation, zirconium hydride, titanium hydride, uranium hydride, thorium hydride, and yttrium and other rare earth hydrides, and any of their deuterated analogs. The key design concerns in selecting metal hydrides include maximizing hydrogen content, maximizing neutron capture cross section, and thermal and chemical stability under operating conditions. Additionally, the neutron absorber is either itself electrically conductive or is embedded in an electrically conductive matrix material. For instance, boron is a poor electrical conductor at room temperature but becomes conductive at high temperatures. Therefore, embodiments intended for room temperature operation could adopt boron-10 as an absorber material provided the boron embedded in a conductive matrix material. This would allow charge to be drained as the boron fission products leave electrons behind the bulk neutron absorber layer.

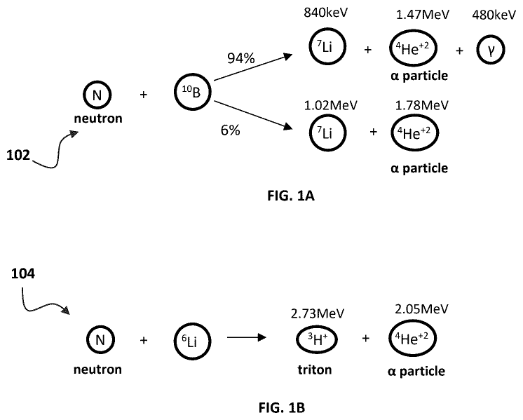

FIGS. 1A and 1B are schematic drawings of known fission reactions 102, 104 of ¹⁰B and ⁶Li. According to FIGS. 1A and 1B, a neutron can be absorbed by a nucleus of boron-10 or lithium 6. The slower the neutron is travelling, the greater the probability that the nucleus will absorb the neutron, rather than reflecting off the nucleus. In the case of boron-10, the fission reaction 102 products usually are a lithium-7 nucleus, an alpha particle (α) and a gamma-ray (γ). In all cases, non-radiative fission products are fully ionized species. Thus, an alpha particle is a fully ionized helium-4 nucleus.

FIG. 1A also shows a less probable fission reaction of boron-10 producing lithium-7 and an alpha particle at higher kinetic energies, and no gamma ray. Alternatively, in FIG. 1B, if a neutron is absorbed by the Lithium-6 nucleus, the fission reaction 104 products are an alpha particle and a triton (t), i.e. an ionized hydrogen-3 nucleus. As these processes continue, electrons accumulate in the neutron absorber material. The material being conductive, the excess electrons are drained off by an electrical connection.

The neutron absorber is not limited to lithium-6 or boron-10. Other known neutron absorbers are also suitable choices. A nonlimiting list of such elements is provided in Table I.

TABLE I
Neutron Absorbers

| Element | Isotope | Thermal Neutron Cross-Section (barns) |
|---|---|---|
| Gadolinium | Gd-157 | ~254,000 |
| Cadmium | Cd-113 | ~20,600 |
| Samarium | Sm-149 | ~42,000 |
| Boron | B-10 | ~3,840 |
| Dysprosium | Dy-164 | ~2,700 |
| Europium | Eu-151 | ~9,200 |
| Hafnium | Natural Hf | ~104 |
| Indium | In-115 | ~200 |
| Silver | Ag-109 | ~91 |
| Lithium | Li-6 | ~940 |

Table II is also provided, showing Figures-Of-Merit for common neutron moderating/absorbing materials. Hydrogen is best at moderating fast neutrons to thermal speeds, averaging 19 collisions to do so. However, it is not the only moderator. All atoms will thermalize fast neutrons, albeit with a higher number of collisions as the atomic weight increases. Many hydrides lose their hydrogen at elevated temperatures, and some hydrides are difficult to work with. Lithium hydride, for example, tends to spontaneously combust if it comes into contact with water vapor in the air. As shown in Table II, a rough Figure-of-Merit (FOM) can be calculated by looking at how many atoms of a particular element are in each cubic centimeter of a material divided by the number of collisions needed to thermalize a 2 MeV neutron (the average energy of a nuclear reactor Watt neutron energy spectrum), as shown in the table below.

TABLE II
Figure-Of-Merit for common neutron moderating/absorbing materials

| | | Molar | Melting | Atom | # of | Figure |
|---|---|---|---|---|---|---|
| | Density | Mass | (or Triple) | Density | Collisions to | of Merit |
| Material | (g/cm\hat{ }3) | (g/mol) | Point (°C) | (#/cm\hat{ }3) | Moderate | (FOM) |
| Lithium Metal | 0.53 | 6.938 | 454 | 4.63E+22 | 68 | 6.81E+20 |
| Lithium Hydride (LiH) | 0.78 | 7.950 | 689 | 5.91E+22 | | 3.98E+21 |
| Li in LiH | | | | 5.91E+22 | 68 | 8.69E+20 |
| H in LiH | | | | 5.91E+22 | 19 | 3.11E+21 |
| Lithium Fluoride | 2.64 | 25.939 | 845 | 6.12E+22 | | 1.25E+21 |
| Li in LiF | | | | 6.12E+22 | 68 | 9.00E+20 |
| F in LiF | | | | 6.12E+22 | 177 | 3.46E+20 |
| Boron Carbide (B4C) | 2.50 | 55.255 | 2350 | 2.72E+22 | | 4.89E+20 |
| B in B4C | | | | 2.72E+22 | 104 | 2.62E+20 |
| C in B4C | | | | 2.72E+22 | 120 | 2.27E+20 |
| Carbon (Graphite) | 2.27 | 12.010 | 4600 | 1.14E+23 | 120 | 9.47E+20 |

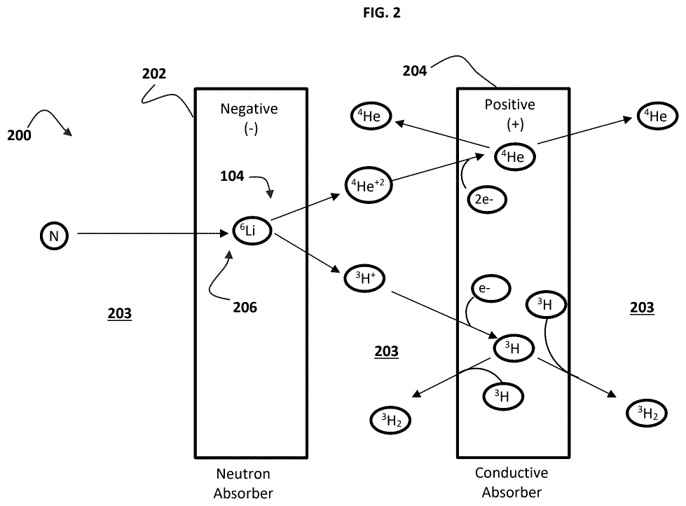

FIG. 2 illustrates the basic principles of a device that uses the fission reaction 104 of FIG. 1B to separate charge. A neutron N is absorbed 206 by a lithium-6 atom of a neutron absorber layer 202. Preferably, the neutron has been thermalized, either prior to impinging the neutron absorber layer 202, or within the layer 202 by a hydride or other known moderator. The lithium-6 atom undergoes a fission reaction 104 producing an alpha particle (⁴He⁺²) and a triton particle (³H⁺), which are ejected from the neutron absorber layer 202 leaving their corresponding electrons behind.

The neutron absorber layer 202 may advantageously be thin to mitigate losses in efficiency due to the alpha and triton particles colliding with and embedding in the neutron absorber 202. Collisions result in reduction of the fission products to neutral species and therefore no net gain, of electrons by the absorber 202. Further, the rate at which energy is converted by such a system can be limited by the efficiency by which the fission products are transmitted from the point where they are generated in the neutron absorber layer 202 to point where they are neutralized in the conductive absorber layer 204. It is desirable, therefore, to limit losses of the fission products due to collisions with the neutron absorber layer or the insulator layer. One way to limit such losses is to interpose a vacuum or a porous insulator in the region 203 between the neutron absorber 202 and the conductive absorber 204. A porous insulator must be sufficiently thick to serve as an electrical insulator, while being sufficiently thin to allow fission products to pass through from the neutron absorber 202 to the conductive absorber, and to further allow for the diffusion of neutral tritium and helium from the conductive absorber out of the embodiment. Furthermore, it may be preferrable to use the same insulator layer 203 throughout the embodiment.

Porous insulators are well known in the art and can be selected as a matter of design choice by the skilled artisan. One class of suitable porous insulators is ceramic aerogels and xerogels (collectively “gels”) such silicon oxide gels having a density of about 0.003 g/cm³. Tungsten oxide may also be suitable and is highly effective as gamma ray and x-ray absorbers, and thus may provide shielding from such radiation produced by the neutron source and through fission reactions within the neutron absorber layer 202. Other suitable insulating materials for use in space 203 include zirconium oxide gels and titanium dioxide gels. Still other materials such as bismuth oxide and lead oxide may be combined with known clays and/or organic resins to produce suitably porous structures that both absorb gamma rays and allow for efficient transport of fission products through space 203.

Embodiments may provide for a porous neutron absorber layer. For example, and without limitation, it is known to make lithium hydride porous by combining it with porous silicon nanowires (PSiNWs) or by sintering. Lithium hydride being highly reactive with water vapor, other less moisture sensitive materials may be preferred in some embodiments based on intended application. For example, lithium fluoride is more stable and is more easily deposited as a thin film. Embodiments using LiF as the neutron absorber may additionally interleave one or more moderator-rich layers comprising hydrogen, deuterium, carbon, beryllium, or other common moderators. Alternatively, such embodiments may interpose a moderator between the neutron source and the power generation device, without interleaving it between the neutron absorber and conductive absorber elements.

Regardless of whether a vacuum or insulator is used, the alpha and triton particles emitted from the neutron absorber 202 component eventually reach a porous conductive absorber 204 component where they are reduced to neutral helium and tritium species and remain in the gas phase. These gas species diffuse out through the porous layers and can be collected for later use or trade. Tritium gas is especially valuable, as it spontaneously undergoes beta decay producing helium-3 gas which is very rare and valuable for achieving near absolute zero temperatures because it boils at 3.2 Kelvin compared to the more abundant helium-4 isotope, which boils at 4.2 Kelvin. However, if recovery of the gases is not desired, they can be easily vented off. The person having ordinary skill will recognize allowing the neutral tritium and helium to diffuse out of the device also carries away heat, thereby helping to manage waste heat generated by the device.

With continuing reference to FIG. 2, it may be advantageous to make the conductive absorber layer 204 porous because a high surface area provides for efficient reduction of fission products while further enhancing their diffusion out of the device. According to Table III, porous tungsten is one material which may comprise the conductive absorber component of the invention, however, the invention is not limited to tungsten or to porous materials. In principle, any electrically conductive material can serve as the conductive absorber layer, however, an advantage of porous tungsten is that it also absorbs gamma emissions from the neutron source and from the neutron absorber. The person having ordinary skill in the art will recognize that other porous materials are also suitable, some of which are identified in Table III including copper, gold, and platinum, which also provide moderate to high attenuation of ionizing radiation. Certain metal organic frameworks (MOFs) may also be suitable for use as conductive absorber layers, however, their electrical conductivities and mass attenuation coefficients vary widely. It is discovered that high atomic number elements such as tungsten that absorb gamma photos may add to the current produced by the device. More specifically, if gamma-rays are passing through in the same direction as the neutrons, they will eject some of the electrons in the 204 layer toward the next 202 layer by means of Compton-scattering. This will increase the overall electrical current.

TABLE III
Porous Metals for Conductive Absorber

| | | Thin Film | γ/X-ray |
|---|---|---|---|
| Metal | Conductivity | Deposition | Absorber |
| Copper (Cu) | Excellent | PVD, sputtering | Moderate |
| Silver (Ag) | Excellent | PVD, solution methods | Moderate |
| Nickel (Ni) | Good | PVD, electrochemical | Moderate |
| Aluminum (Al) | Moderate | PVD | Low |
| Gold (Au) | Excellent | Reduction, templating | High |
| Platinum (Pt) | Excellent | Reduction, templating | High |
| Tungsten (W) | Good | PVD, CVD, ALD | Very High |
| MOFs | Variable | PVD, CVD | Variable |

Low: mass attenuation coefficient (MAC) < 0.1 cm²/g for photon energies between 100 keV-1 MeV
Moderate: MAC between 0.1-0.5 cm²/g
High: MAC between 0.5-1.5 cm²/g
Very High: MAC > 1.5 cm²/g

With continuing reference to FIG. 2, the conductive absorber 204 has an electron deficit because it has donated electrons to reducing the fission products to neutral species. The potential difference between the neutron absorber 202 (negative) and the conductive absorber 204 (positive) provides a source of electrical energy for useful work.

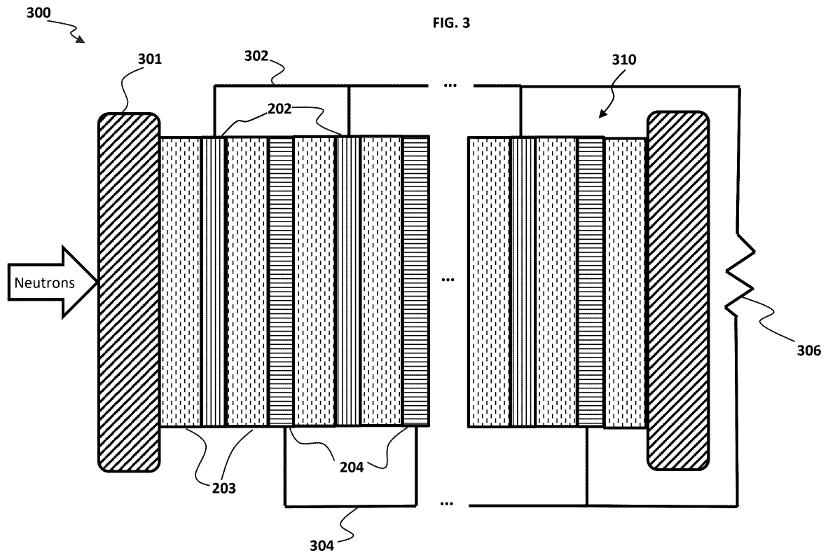

Turning to FIG. 3, a schematic drawing of a neutron energy conversion device 300 is provided. Neutrons are shown entering the device 300 from left to right. An enclosure 301 surrounds and protects the internal layered structure from mechanical damage. A suitable material for the enclosure includes aluminum and alloys thereof, though aluminum is not required. Nonetheless, aluminum may be advantageously used for its relative transparency to neutrons (roughly 0.2 barns) and its wide availability and machinability. Other materials like titanium could replace aluminum, however, it is less machinable than aluminum, and less transparent to neutrons (roughly 6 barns). Certain other metals have varying degrees of suitability as an enclosure, including vanadium, zirconium, and niobium. All of these are more difficult to machine than aluminum and titanium. As used herein when referring to materials as neutron transparent or neutron opaque, it will be understood by the person of ordinary skill that neither term is meant in its absolute sense. Rather, a material that is dubbed neutron transparent is one that passes a useful percentage of neutron flux and therefore enables generation of a useful amount of electric power for a given application. Conversely, a neutron opaque material is one that does not pass a useful amount of neutron flux. Many of the materials discussed herein could be regarded as neutron transparent or neutron opaque depending on variables like their thickness and the power generation requirements of a given application. Thus, the definition of these terms is functional in its focus, and the precise meaning is readily ascertained by the person of ordinary skill in the art without undue experimentation.

With continuing reference to FIG. 3, the enclosure 301 contains an energy converting member 310 comprising repeating layers starting with aerogel insulation 203 adjacent to the enclosure 301, followed by a neutron absorber layer 202, a second insulating layer 203, and then a conductive absorber layer 204. The ellipses shown in FIG. 3 indicate that a portion of the structure is omitted from the drawing for space, but repeats according to the established pattern. The illustrated architecture is suitable for embodiments that either need not thermalize neutrons e.g., because the incoming neutron flux is already thermalized, or that incorporate a moderator into the neutron absorber 202. For instance, a neutron absorber layer of LiH incorporates hydrogen as a moderator, whereas a layer of LiF may require an additional component to covert high speed neutrons to thermal neutrons. Alternatively, the significantly higher density of LiF versus LiH, as shown in Table II, can be exploited to allow Li to function as the moderator despite its lower efficacy.

Each neutron absorber layer 202 electrically communicates with an external circuit through negative leads 302. Likewise, each conductive absorber layer 204 communicates with the external circuit through positive leads 304. A generic load 306 is shown on the right of FIG. 3. The ordered combination of a neutron absorber 202, a first insulating layer, a conductive absorber, and a second insulating layer forms a repeatable unit of the energy conversion member 310. The units are assembled by building up these layers in the same order according to known means appropriate to material selections made by the skilled artisan as a matter of design choice. For instance, known methods include chemical vapor deposition, physical vapor deposition, sputtering, and various form of lithography. Further, where sufficiently thin foils are available, the layers of an energy conversion member 310 could even be assembled by hand in a glove box or dry room.

Furthermore, the invention is not limited to a particular number of layers or units. The person skilled in the art will understand how to determine a number of layers suitable for a given application. For example, it will be understood that neutron flux will attenuate from left to right in FIG. 3, as neutrons are absorbed. It will be further understood that current generation will likewise diminish with neutron flux. Therefore, it would be unnecessary to include layers after the anticipated neutron flux is attenuated below a useful level. When the neutron flux drops below a certain level, in a given application, each additional layer will add cost and weight without adding a worthwhile amount of power. The minimum operative neutron flux below which adding further layers makes no engineering sense can be readily determined by the skilled artisan by taking account of the anticipated maximum flux of a given neutron source, the power conversion efficiency of the embodiment, the power requirements of the given application, weight limitations, and cost limitations. As used herein with respect to neutron radiation, the term operative amount, means a rate of neutron flux sufficient to produce a useful amount of electric power for a given application. In other words, an operative amount is an amount that enables an embodiment to operate as designed. This quantity is readily calculated by the skilled artisan without undue experimentation.

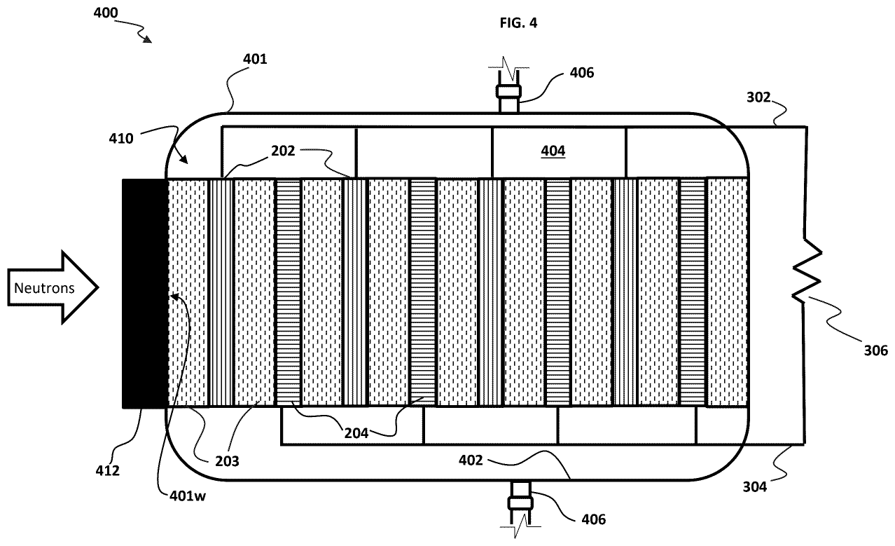

FIG. 4 is a cross-sectional view showing additional details of an embodiment 400 similar to that of FIG. 3. In the illustrated embodiment, the housing 401 may be substantially all composed of a neutron transparent material such as aluminum. As used here the term substantially all means all but incidental structures (e.g. fasteners, gaskets, lubricants and so on) are neutron transparent. However, embodiments may instead provide a neutron transparent window 401w with the balance of the housing made from a material with no, or significantly less, neutron transparency. In active shielding embodiments the portion of the housing facing a nuclear reactor may be made from a neutron transparent material, while the balance is not. In nuclear battery embodiments, the neutron source may be inside the device. In such cases, the housing need not have good transparency to neutrons.

Continuing with FIG. 4, the housing 401 is shown surrounding a multilayered energy conversion member 410. The energy conversion member 410 comprises a series of layers from an interior surface 402 of the housing 401 at the left side of FIG. 4 to the interior surface 402 at the right side of FIG. 4. The person of ordinary skill will understand that structures 401 and 401w would be distinct in embodiments having a neutron-transparent window in an otherwise neutron opaque housing, but where the entire housing is neutron transparent (as in an aluminum housing) structure 401w indicates a particular region of the housing 401 interposed in the neutron flux. The layer adjacent to the housing is an insulating layer 203. Where the housing is conductive, insulation is necessary to prevent current leakage to the housing in any embodiment where the housing provides support to the energy conversion member 410. For example, the embodiments illustrated in FIGS. 3 through 6 contemplate a housing that mechanically supports the energy conversion member 410. However, in other embodiments the energy conversion member 410 may be only indirectly supported by the housing. That is, it may be in direct contact with other components that do not form a part of the housing. For instance, insulative spacers may be provided in the form of posts or blocks that attach to the housing and upon which the energy conversion member 410 mounts. The term insulating members encompasses both insulative spacers and insulating layers. Insulative spacers and insulating layers may or may not differ in material composition, or in the manner of their integration with the housing and energy conversion member. All such variations are well within the skill of the art, and can be selected by the skilled artisan as a matter of design choice.

According to the embodiment illustrated in FIG. 4, the insulating layer 203 may repeat through the layered energy conversion member 410, however, this is not a requirement. Rather, the insulation on the interior of the housing 401 could be different in material composition and/or method of application as compared to the insulation used throughout the energy conversion member 410. With respect to the housing insulation, the operative principle is that the insulation lining the housing must be sufficient to prevent current leakage to the housing. In contrast, the insulating layers of the energy conversion member 410 must not only prevent shorting, they must also be sufficiently porous to permit alpha particles and triton particles to flow from the neutron absorber 202 to the conductive absorber 204 with minimal thermal energy losses.

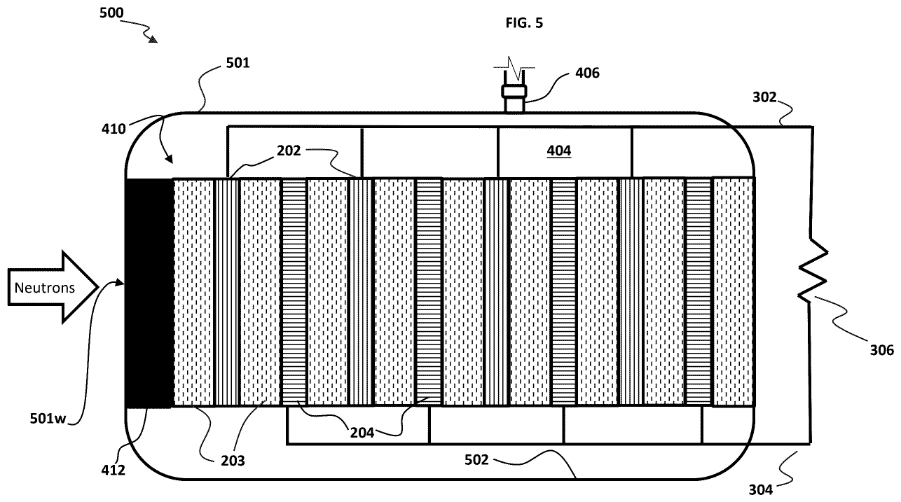

According to the illustrated embodiment, the multilayered neutron energy conversion member 410 is positioned in line with an external moderator 412 such as high-density polyethylene (HDPE). The location of the moderator can differ depending on certain design choices. For instance, the present embodiment may have no moderator incorporated in the neutron absorber layer 202. As discussed elsewhere herein the neutron absorber layer 202 could be made from a hydrogen or deuterium-rich material like lithium hydride or lithium deuteride, in which case the same layer is effective for thermalizing neutrons and absorbing neutrons. However, neutron absorber layers made from poor moderator materials like lithium fluoride, may advantageously include a separate moderator component, such as component 412, between itself and the neutron source. Furthermore, it may improve energy conversion efficiency to thermalize a large number of neutrons prior to impinging the energy conversion member 410 so that each neutron absorber layer 202 receives a larger flux of thermal neutrons than it would if moderation occurred in the neutron absorber layer. The exact placement of the moderator member 412 is not critical provided it is between the neutron source and the energy conversion member 410. For example, it could be placed inside the housing as shown in FIG. 5, rather than outside as shown in FIG. 4, to provide better protection from damage to the moderator member. For example, and without limitation, in one embodiment the moderator may coat the interior surface of the housing. In such embodiments, electrical insulation may be placed between the moderator and the neutron absorber 202 if the moderator is electrically conductive. Nonconductive moderators such as polyolefins may not require additional insulation, and may be placed in contact with the neutron absorber.

With further regard to FIG. 4, the embodiment 400 space 404 is provided inside the housing 401 to receive gases generated by the fission reactions occurring in the energy conversion member 410. The embodiment further includes a gas collection port 406 in fluid communication with the internal gas accumulation space 404, which may comprise, for example, a fitting in a wall of housing 401. The port 406 provides a means of fluid communication for collecting or otherwise disposing of the tritium and helium gases produced by the energy conversion member 410. A second port 406 may be provided to enable a flow of a carrier gas or flush gas through the device 400. Such a feature would continuously clear gas reaction products from the device, remove some of the heat produced in operating the device, and prevent the intrusion of unwanted gases like water vapor that may harm moisture sensitive components e.g., those made from lithium.

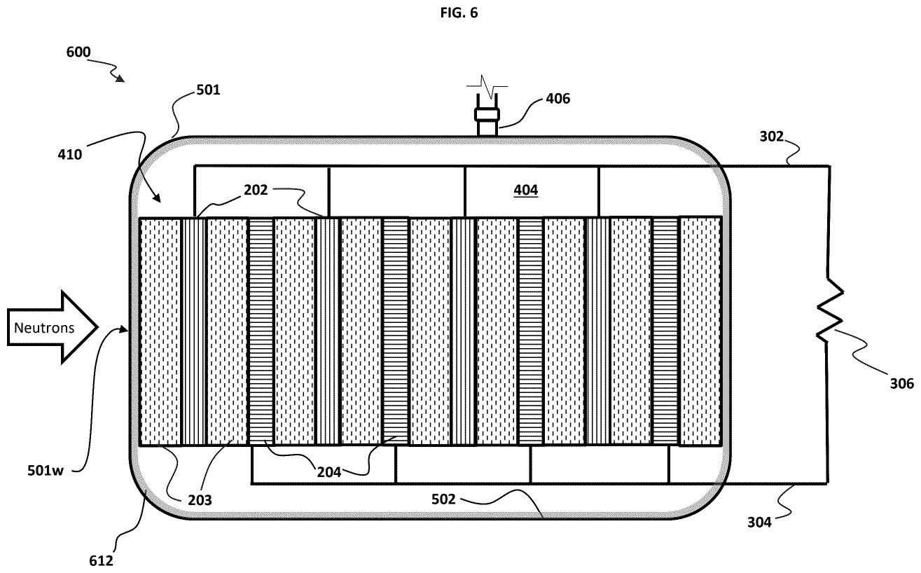

FIG. 5 illustrates and embodiment 500 similar to that of FIG. 4 except that the moderator 412 is located inside the housing 501, behind an inside surface 502 of the housing 501 comprising a neutron transparent window 501w. FIG. 6 illustrates another embodiment 600 where the moderator component 412 of FIGS. 4 and 5 is replaced by a moderator coating 612 over the entire inside surface 502 of the housing.

### Layer Thickness

Thickness requirements for neutron absorbers, conductive absorbers, and insulators are estimated using the Stopping and Range of Ions in Matter (SRIM) code. The key consideration for a neutron absorber is to be thin enough to allow both triton and alpha particles to escape. For conductive absorber layers, minimum thickness is more important because a certain minimum is necessary to convert substantially all the triton and alpha particles to neutral species. In regard to insulators, the thickness must be minimized to permit charged fission products to pass through and neutral species to escape, while still serving as an effective electrical insulator. Table IV summarizes depth of penetration estimates determined through the SRIM simulation.

TABLE IV
Ranges of Tritons and Alphas in some materials of interest.

| | | 2.73 | 2.05 |
|---|---|---|---|
| | | MeV Triton | MeV Alpha |
| | Density | Penetration | Penetration |
| Material | (g/cm³) | Depth (μm) | Depth (μm) |
| Aluminum (Al) | 2.70 | 38.2 | 6.74 |
| Silica Aerogel (SiO2) | 0.10 | 915 | 160 |
| Silica Aerogel (SiO2) | 0.003 | 30600 | 5330 |
| Boron (B) | 2.08 | 33.0 | 5.19 |
| Carbon (C) -- Graphite | 2.0 | 32.2 | 5.62 |
| Carbon (C) -- Graphene | 1.50 | 47.8 | 8.49 |
| Kapton ® | 1.42 | 51.8 | 8.66 |
| Lithium Metal (Li) | 0.533 | 134 | 23.3 |
| Lithium Hydride (LiH) | 0.820 | 69.5 | 11.8 |
| Lithium Fluoride (LiF) | 2.64 | 33.7 | 6.05 |
| Silicon (Si) | 2.33 | 43.3 | 7.5 |
| Teflon ® (C2F4) | 2.20 | 41.2 | 7.4 |
| Tungsten Metal (W) | 19.3 | 15.2 | 2.77 |
| Tungsten Foam (W) | 2.0 | 100.0 | 26.8 |
| Tungsten Hydride (WH) | 9.71 | 28.3 | 5.2 |

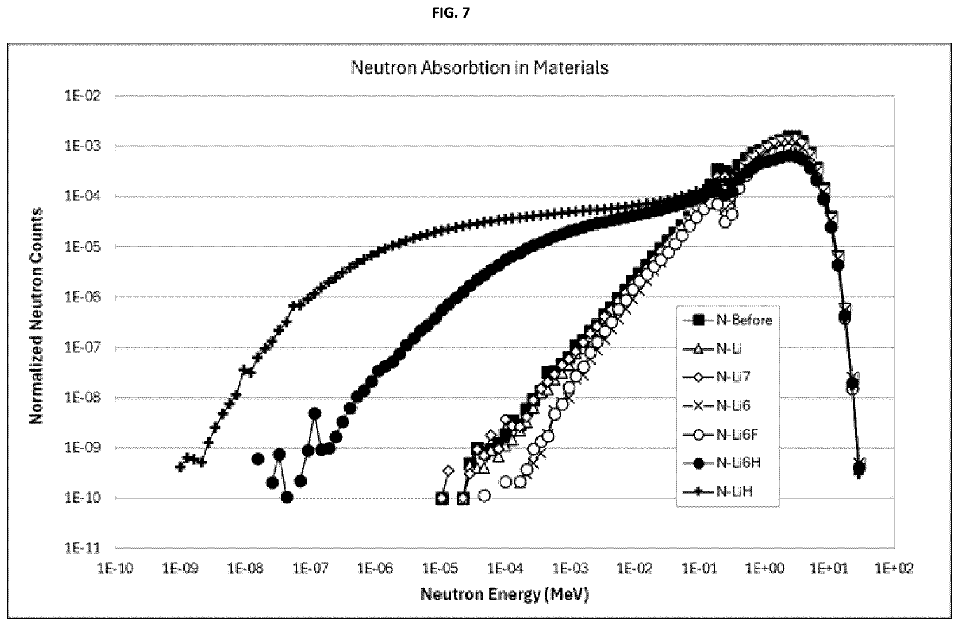

Simulations have been performed using Monte-Carlo N-Particle (MCNP) transport code which, along with GEANT-4, is the standard in nuclear engineering. MCNP version 6.2 tracks alphas particles, triton particles, gamma photons and electrons, giving a fuller picture of the situation than Monte-Carlo N-Particle extended (MCNPX) within the device. Looking at how much of the original neutron flux is absorbed in a 148-layer device gives an indication of the scaling factor that would yield a device that can exploit the entire incoming neutron flux. The neutron-moderating, neutron-absorbing and alpha- and triton-producing capabilities of several materials were simulated. FIG. 7 shows how a 5-cm slab of various materials affect the number and energy distribution of a nuclear reactor Watt spectrum, before entering the slab, and after exiting the slab. The simulation did not allow neutrons to leak out the sides of the slab, to ensure an apples-to-apples comparison. The counts in FIG. 7 are normalized to a single input particle.

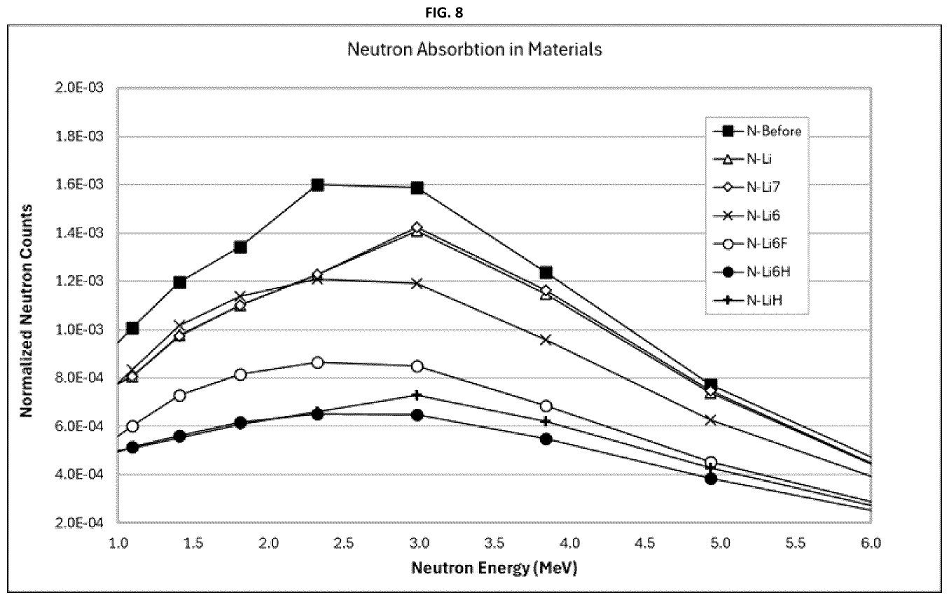

With reference to FIG. 8, Lithium-7 and Natural Lithium (93% Li-7) can moderate the neutrons to lower energy, but are not good absorbers, so the plot of FIG. 7 shows more neutrons exiting the material at lower energies than with Li-6, which moderates the neutrons to thermal energy then absorbs the neutrons, producing alphas and tritons. Looking at the lower energies gives an indication of how well the material absorbs the moderated neutrons. However, to see how well the materials moderate the neutrons to lower energy, it is more instructive to look at the higher end of the energy spectrum, as shown in FIG. 8.

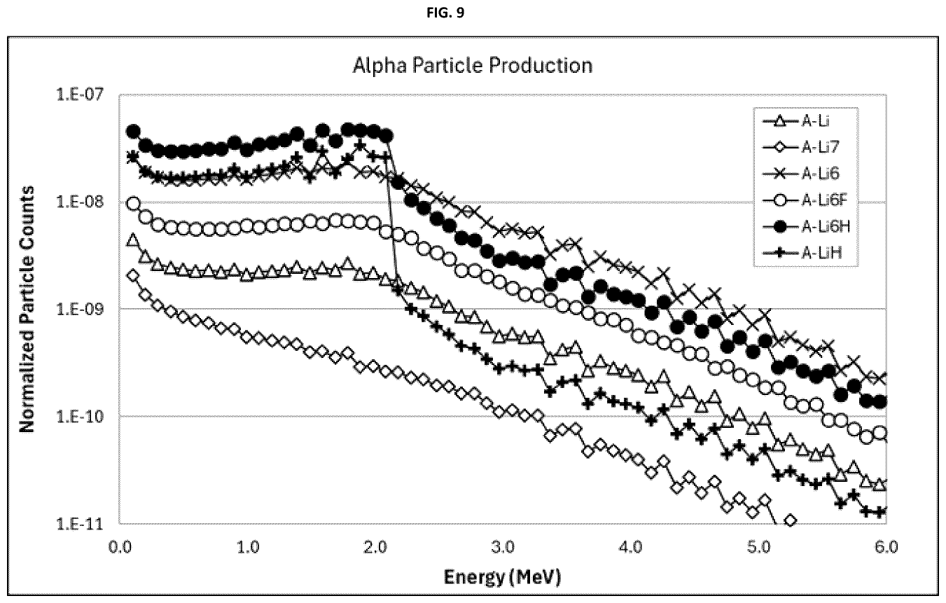

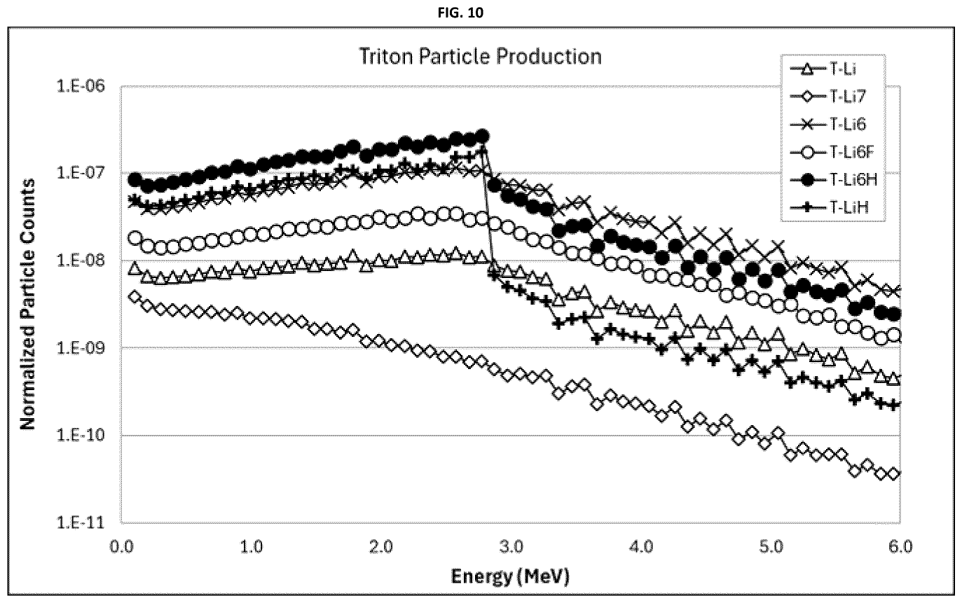

When comparing the shielding efficiency for neutrons, it is a combination of how well a material moderates the faster neutrons (1-2 MeV) down to ‘thermal’ energy (0.23 eV), and how well the material absorbs the thermal neutrons, usually producing charged particles. The present invention is concerned with not just how well a material shields neutrons, but by how well it produces alphas and tritons, which will be used to transfer electric charge. FIGS. 9 and 10 show the normalized relative amount of alpha and triton production in selected materials. The counts are normalized to a single neutron, and are therefore much less than 1.

FIGS. 9 and 10 show alpha particle production (FIG. 9) and triton production (FIG. 10) within a 5 cm slab of material. Lithium-7 and natural lithium show relatively low levels of charged-particle production, since it is the Li-6 that produces the tritons and alphas. Lithium-6 hydride shows the highest level of production since the hydrogen is the best moderator, but a poor absorber, while Li-6 is an excellent absorber, but less than one-third as good of a moderator as hydrogen. Lithium-6 fluoride is the next best producer even though fluorine is 2.6 times less of a moderator as lithium and only 1/9 as good of a moderator as hydrogen. The fluorine is highly attractive to the lithium atoms and draws them so close together that the density of lithium atoms in LiF is higher than the density of lithium atoms in pure lithium metal. Table V summarizes the percentage loss of neutrons passing through the material and the relative numbers of tritons and alphas produced, normalized to the best producer (Li6-H).

TABLE V

| Material | % Neutron loss | Tritons | Alphas |
|---|---|---|---|
| Natural Lithium (Li) | 17.92 | 0.070 | 0.078 |
| Lithium-7 (7Li) | 17.77 | 0.012 | 0.019 |
| Lithium-6 (6Li) | 19.72 | 0.607 | 0.618 |
| Lithium Hydride (LiH) | 33.96 | 0.522 | 0.526 |
| Lithium-6 Hydride (6Li—H) | 40.18 | 1.000 | 1.000 |
| Lithium-6 Fluoride (6Li—F) | 45.79 | 0.190 | 0.203 |

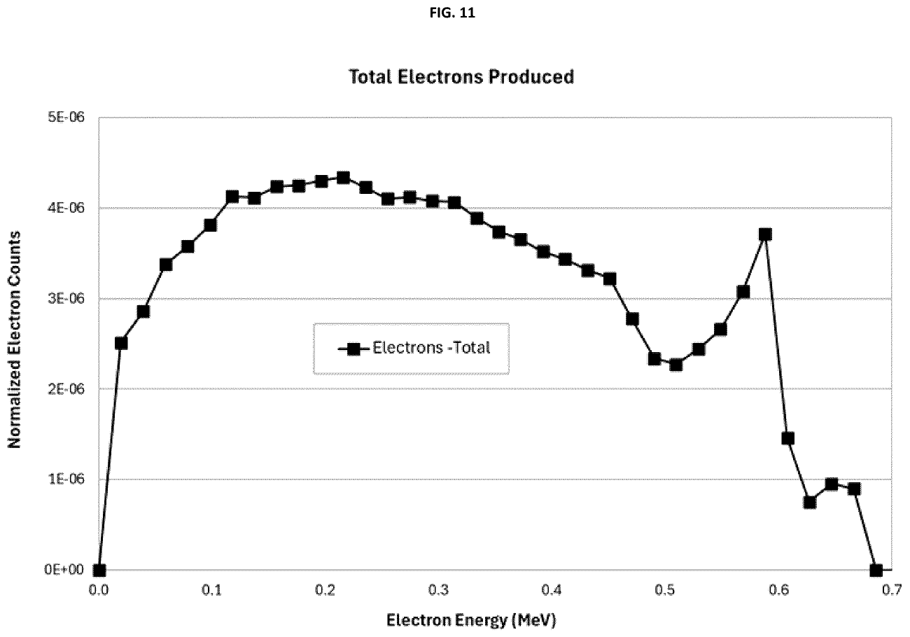

FIG. 11 is a simulation plot of the energy spectrum of electrons produced through Compton scattering in 148-layer embodiment from 662 keV gamma-rays, normalized to a single incoming gamma photon. The simulation was performed with MCNP6 where the neutron absorber layer is Li-6 foil and the conductive absorber layer is tungsten (W), all of 30 μm thickness. The insulator layer is silica aerogel of 70 μm thickness. The simulated device had 148 layers of alternating Li-6, aerogel, tungsten, aerogel, Li-6, and so on, housed in aluminum box. The overall device is calculated to be about 2 cm thick including the housing. The total thickness of Li-6 and W was 1.05 mm each. The simulation shows how the neutrons and gammas would be attenuated, and how much charge would be produced. Even with this small amount of Li-6 and tungsten, 2.47% of the neutrons entering the device were absorbed, and 10% of the gammas absorbed. FIG. 11 shows the energy distribution of the electrons produced. The electrons, tritons and alpha particles strike the tungsten plates with energies in the range of Mega-electron-Volts (10⁶ eV). The achievable voltage difference between the positive and negative leads would be limited by the breakdown voltage of the aerogel insulating layers.

Where the neutron absorber layer is lithium-6, each moderated and absorbed neutron would result in three conduction electrons being generated. Using a conservative estimate of 1 electron produced per gamma ray absorbed and using typical neutron and gamma reactor fluxes of 10¹³/cm²/sec, a total of 10¹⁵ electrons is expected to be produced per cm²/sec, or 1.65×10⁻⁴ Amps. Assuming the breakdown voltage of the insulator is 5000 Volts, that leads to a wattage of 0.825 W/cm². It is expected that when the device is not connected to a load, there will be a shunt resistor connected across the leads, to avoid excessive voltage buildup between the neutron absorber layers and the conductive absorber layers.

It will be apparent to those skilled in the art that the above methods and apparatuses May be changed or modified without departing from the general scope of the invention. The invention is intended to include all such modifications and alterations insofar as they come within the scope of the appended claims or the equivalents thereof.

Having thus described the invention, it is now claimed:

1. An energy conversion device, comprising:
a housing having (301) an interior surface (402) enclosing a multilayered energy conversion member (410), wherein at least a portion (400) of the housing is suitably transparent to neutron radiation to permit an operative amount of neutron radiation to pass through the housing and impinge the multilayered energy conversion member;
an insulating member disposed on the interior surface of the housing; and
the multilayered energy conversion member comprising:
a neutron absorber layer disposed on the insulating member, wherein the neutron absorber layer is in electrical communication with an electrical lead attachable to an external circuit;
a first insulating layer disposed on a face of the neutron absorber layer opposing the insulating member; and
a conductive absorber layer disposed on the insulating layer, wherein the conductive absorber layer is in electrical communication with an electrical lead attachable to the external circuit.

2. The energy conversion device of claim 1, further comprising a second insulating layer disposed on a face of the conductive absorber layer opposing the first insulating layer, wherein the ordered collection of the neutron absorber layer, the first insulating layer, the conductive absorber layer, and the second insulating layer comprise a unit of the multilayered energy conversion member.

3. The energy conversion device of claim 2, wherein the multilayered energy conversion member comprises a plurality of units.

4. The energy conversion device of claim 1 further comprising a moderator member disposed inline of an anticipated neutron flux on an inside surface of the housing, or on an outside surface of the housing.

5. The energy conversion device of claim 1 further comprising a moderator coating disposed inline of an anticipated neutron flux on an inside surface of the housing.

6. The energy conversion device of claim 1, wherein the housing is substantially all composed of a neutron transparent material, or wherein the housing is composed of a neutron opaque material with a neutron transparent window installed inline with an anticipated neutron flux.

7. The energy conversion device of claim 1 further comprising a gas accumulation space within the housing.

8. The energy conversion device of claim 7 further comprising at least one gas port in fluid communication with the gas accumulation space.

9. The energy conversion device of claim 1, wherein the neutron absorber layer comprises a material selected from the group consisting of gadolinium-157, cadmium-113, samarium-149, boron-10, dysprosium-164, europium-151, hafnium, indium-115, silver-109, or lithium-6.

10. The energy conversion device of claim 1, wherein the conductive absorber layer comprises a material selected from the group consisting of copper, silver, nickel, aluminum, gold, platinum, or tungsten.

11. The energy conversion device of claim 1, wherein the conductive absorber layer ejects Compton electrons scattered by incident gamma photos, and the ejected Compton electrons are received by a neutron absorber layer.

12. The energy conversion device of claim 1, wherein the insulating member comprises an aerogel.

13. The energy conversion device of claim 1, wherein the first insulating layer comprises an aerogel.

14. A multilayered energy conversion device comprising:
a neutron absorber layer, wherein the neutron absorber layer is in electrical communication with an electrical lead attachable to an external circuit;
a first insulating layer disposed on a face of the neutron absorber layer; and
a conductive absorber layer disposed on the insulating layer, wherein the conductive absorber layer is in electrical communication with an electrical lead attachable to the external circuit.

15. A multilayered energy conversion device of claim 14, further comprising a second insulating layer disposed on a face of the conductive absorber layer opposing the first insulating layer, wherein the ordered collection of the neutron absorber layer, the first insulating layer, the conductive absorber layer, and the second insulating layer comprise a unit of the multilayered energy conversion device.

16. A multilayered energy conversion device of claim 15, wherein the multilayered energy conversion device comprises a plurality of units.

17. A multilayered energy conversion device of claim 14 wherein the neutron absorber layer comprises a material selected from the group consisting of gadolinium-157, cadmium-113, samarium-149, boron-10, dysprosium-164, europium-151, hafnium, indium-115, silver-109, or lithium-6.

18. A multilayered energy conversion device of claim 14, wherein the conductive absorber layer comprises a material selected from the group consisting of copper, silver, nickel, aluminum, gold, platinum, or tungsten.

19. A multilayered energy conversion device of claim 18, wherein the conductive absorber layer is a metal organic framework.

20. A multilayered energy conversion device of claim 14, wherein the first insulating layer comprises a aerogel.
